(19) United States
(12) Patent Application Publication
(10) Pub. No.: US 2005/0104461 A1
(43) Pub. Date: May 19, 2005

(54) Method and system for assembling an electricity generating unit

(76) Inventors: Ernst Hatz, Ruhstorf/Rott (DE); Franz Moser, Schardenberg (AT)

Correspondence Address: KATTEN MUCHIN ZAVIS ROSENMAN, 575 MADISON AVENUE, NEW YORK, NY, 10022-2585, US

(21) Appl. No.: 11/018,040

(22) Filed: Dec. 21, 2004

Related U.S. Application Data
(63) Continuation of application No. PCT/EP03/06152, filed on Jun. 12, 2003.

(30) Foreign Application Priority Data
Jun. 25, 2002 (DE) 102 28 225.0

(51) Int. Cl. H02K 7/00; H02K 21/12

(52) U.S. Cl. 310/67 R; 29/596; 310/156.56; 310/261

(57) ABSTRACT

The invention relates to a method and system for assembling an electricity generating unit consisting of a generator and a reciprocating engine as the drive, in particular for centring an internal stator that is positioned inside an external rotor with an air gap. Said method comprises the following steps: mounting the external rotor onto the drive motor and connecting the rotor to the drive system of said motor; inserting at least two centring bolts, which are offset in the peripheral direction, into centring grooves that are provided in the rotor/stator for partially receiving, (when viewed from a radial direction), said centring bolts that bridge the air gap; centring the stator in the rotor by inserting said stator along the centring bolts inside the rotor; fixing the stator to the generator housing and fixing said generator housing to a connection housing of the drive motor, removing the centring bolts from the air gap.

### CROSS-REFERENCE TO RELATED APPLICATION

This application is a continuation of International Application No. PCT/EP2003/006152, which was filed on Jun. 12, 2003 and claims priority from German Patent Application 102 28 225.0 filed on Jun. 25, 2002, all of which are herein wholly incorporated by reference.

The present invention concerns a method and system for assembling an electricity generating unit comprised of a generator and a reciprocating internal combustion engine as the drive. In particular, it concerns the centering of an internal stator arranged with an air gap inside an external rotor.

Electricity generating units made from a generator and a driving reciprocating internal combustion engine, and the assembling thereof, are known.

For example, DE 100 10 248 A1 of the same applicant describes an electrical generator of this kind with a stationary armature winding and permanent magnet arranged in the rotor for exciting the generator, the rotor being an external rotor forming the flywheel of the Diesel motor and the stator carrying the armature winding and being arranged inside the rotor. Furthermore, the rotor is mounted on a fan wheel, which in turn is flanged onto the crankshaft of the drive motor by its end face. The stator is formed as a stack of laminated iron plates, which carries the armature winding, and is screwed together with an inner ring of a cover of the generator casing, provided at the exhaust side, by means of stator bolts, led through boreholes in its stack of plates and clamping the stack of plates together. The rotor is formed as a stack of laminated iron plates, which carries the permanent magnets for generating a rotating magnetic field, and is screwed together with the fan wheel several times at the periphery by means of clamping bolts, led through boreholes in its stack of plates and clamping the stack of plates together.

For the assembling of the electrical generator, the rotor is fastened by the clamping bolts to the fan wheel, which in turn is flanged to the crankshaft of the drive motor by its end face. The generator casing is then arranged by means of fastening bolts on a connection casing at the engine side. In order to fix the stator to the generator casing, the stator is fastened to the cover of the generator casing by means of stator bolts. Finally, the cover is placed on the generator casing and fastened there by means of stud bolts.

Since the stator is only indirectly positioned inside the rotor, the stator can only be indirectly centered in the rotor. The centering of the stator therefore depends on the following installation tolerances: installation tolerance when fastening the rotor to the fan wheel, installation tolerance when fastening the generator casing to the connection casing at the engine side, which for its part has already been mounted with an installation tolerance on the fan wheel or crankshaft, installation tolerance when fastening the stator to the cover of the casing and installation tolerance when fastening the cover of the casing to the generator casing. These installation tolerances, which in the worst case can even add together, considerably impede a centered installation of the stator. An improved centering of the stator could only be achieved by fastening the stator directly onto the generator casing, which would at least avoid the installation tolerance for fastening the stator to the cover of the casing and the fastening of the cover of the casing to the generator casing. However, only a direct centering of the stator in the rotor can provide a noteworthy improvement.

Yet a precise centering of the stator in the rotor with a precisely maintained air gap is indispensable for a trouble-free functioning of the electrical generator. Every ignition stroke of the reciprocating internal combustion engine produces bending of the crankshaft, which is transmitted to the fan wheel, flanged to it, and the rotor mounted thereon. If during one such bending the rotor is deflected and strikes against the stator, one can expect heavy wear or even loss of function of the electrical generating unit within a short time. Such rotor deflections cannot be entirely prevented, but they have to be corrected. This can be done by means of an appropriately large-dimensioned air gap between rotor and stator, but that requires a precisely centered stator. If the stator deviates but slightly from the predetermined centered position, it is no longer possible to preclude the rotor from hitting the stator during a rotor deflection caused by ignition stroke.

The purpose of the present invention is to overcome the drawbacks of the indirect centering of the stator within the rotor, as is known from the state of the art. This purpose is accomplished according to one proposal of the invention by the features of the independent claims. Advantageous embodiments of the invention are given by the features of the dependent claims.

According to the invention, a method is indicated for the assembling of an electricity generating unit consisting of a generator and a reciprocating internal combustion engine as the drive, especially for a centering of an internal stator arranged with an air gap inside an external rotor, comprising the following steps:

First of all, the external rotor of the generator is fastened to the drive motor and connected to the driving system of the drive motor; this can take place, for example, in that the rotor is connected to a fan wheel, which in turn is fastened to a crankshaft of the drive motor by its end face.

Next, at least two centering bolts, set off from each other in the peripheral direction, are inserted in centering grooves that are provided in the rotor/stator for partially receiving, when viewed from a radial direction, said centering bolts that bridge the air gap. The centering grooves are shaped such that a centering bolt inserted into a centering groove has a portion protruding in the radial direction from the centering groove.

The stator is then centered inside the rotor, the stator being introduced along the centering bolts inside the rotor. If both rotor and stator have centering grooves, when centering the stator a centering bolt already inserted into a centering groove of rotor or stator is inserted into a centering groove of rotor or stator on the other side of the air gap.

The stator is then secured in the centered position to the generator casing. For this, the stator can be fastened to a cover of the casing, which is to be fastened to the generator casing. The generator casing, in turn, is mounted on a connection casing at the motor side, before or after the fastening of the stator.

Finally, the centering bolts have to be removed from the air gap. This can be done, for example, in that the centering bolts are pulled out from the generator through holes arranged in the cover of the casing.

If the centering pins are present in a special shape, namely, in the shape of a cylindrical part cut with a flat cross-sectional surface along the cylinder axis, the possibility exists of turning the centering pins until they no longer have portions protruding from a centering groove in the radial direction. The prerequisite for this is that a centering bolt can be fully accommodated in a centering groove, i.e., the flat cross-sectional surface for such an initially cylindrical centering bolt must be positioned inside the cylinder so that the maximum perpendicular distance of a point on the periphery from the cross-section surface is less than or equal to the depth of a centering groove. The centering bolt should then also be secured in this position by a suitable retention system, which can be accomplished by a spring, for example.

Thus, in extremely advantageous manner, a direct centering of the stator in the rotor occurs according to the invention. Any installation tolerances during the installing of the rotor or other structural parts, which play a role for the centering in the state of the art, are insignificant here.

Moreover, a suitable arrangement is proposed for carrying out the method of the invention. This arrangement comprises an electrical generating unit made from a generator and a reciprocating internal combustion engine as the drive, in particular, a synchronous generator and a Diesel motor, as well as centering pins provided for centering the stator within the rotor. The generator has an external rotor mounted on the drive motor and an internal stator fastened on the generator casing. The arrangement of the invention is characterized in that the rotor or stator is provided, at its peripheral surface bordering on the air gap, with at least two centering grooves running axially and open toward the air gap, in which a centering bolt is partially received, looking in the radial direction, and the other peripheral surface is centered against the centering bolt. Thus, the centering grooves are configured such that the centering bolts have portions projecting radially outward from the centering grooves.

In an especially advantageous embodiment of the invention, both peripheral surfaces are provided with centering grooves, in which the centering bolts are partially accommodated. The rotor can be mounted on a fan wheel, which in turn is fastened on a crankshaft of the drive motor by its end face. Moreover, the rotor can be configured, for example, as a laminated iron plate stack, which carries the permanent magnets for generating a rotating magnetic field and is screwed together with the fan wheel in several places on the periphery by means of clamping screws led through boreholes in its plate stack and clamping the plate stack together.

The stator can be fashioned as a laminated iron plate stack, which carries the armature winding, and is screwed together with an inner ring of a cover of the generator casing, provided at the exhaust side, by means of stator bolts that are led through boreholes in its plate stack, clamping the plate stack together.

The invention shall now be explained more closely by means of a sample embodiment, making reference to the enclosed drawings. These show:

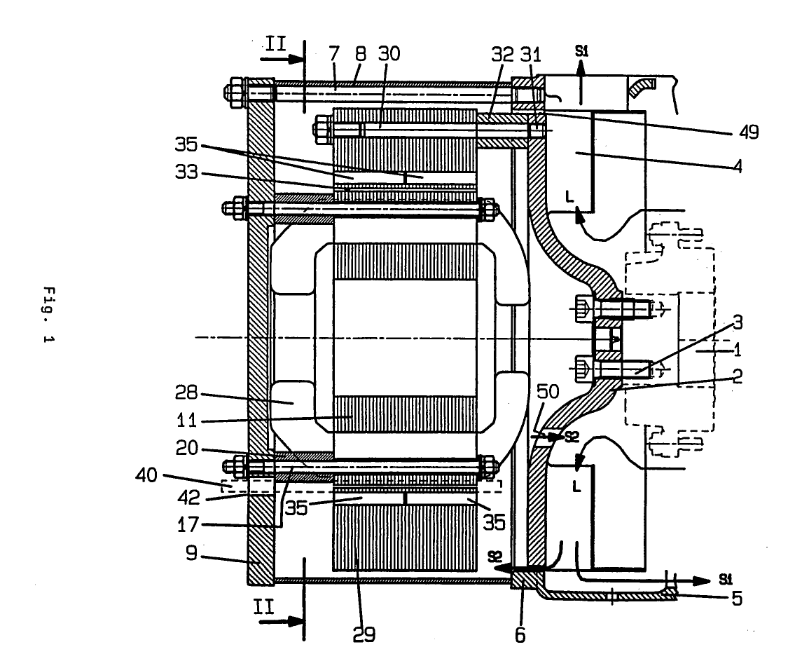

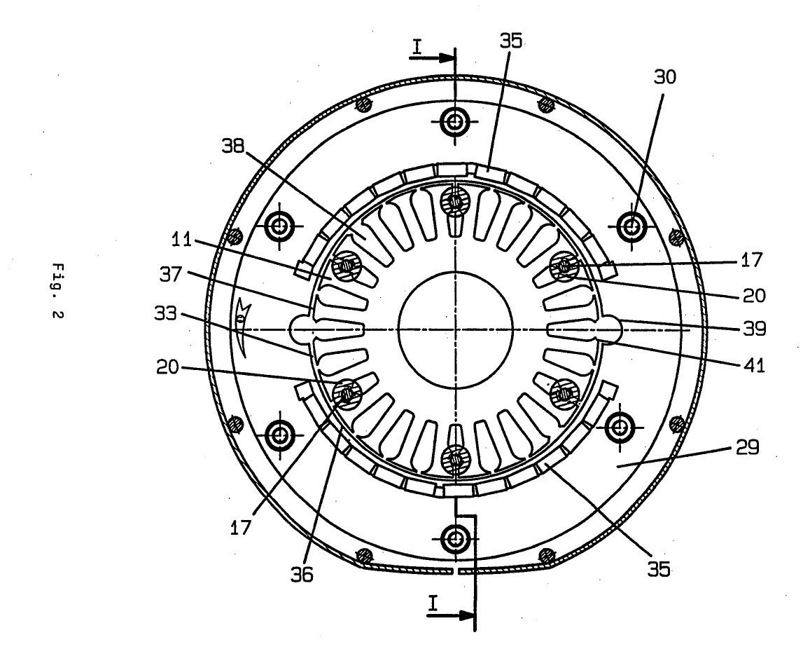

FIG. 1 an axial section through a motor/generator unit along I-I of FIG. 2,

FIG. 2 a view of the stator and the rotor of the motor/generator unit along section II-II of FIG. 1.

The electrical machine depicted in FIG. 1 and 2, forming an electrical generator, involves a unit consisting of a drive motor and a synchronous generator. As the drive motor, a Diesel motor is preferably used, of which only the end of its crankshaft 1 at the connection side is shown by broken lines. At the end face of the crankshaft 1, a fan wheel 2 is mounted by means of screws 3. The fan wheel 2 has blades 4 for taking in a stream of air per arrow L and creating an air flow per arrow S1 for the motor cooling and arrow S2 for the generator cooling.

A connection casing 5 at the motor side encloses the space in which the fan wheel 2 is accommodated, in the radially outward direction; it is open toward the motor and has at its opposite side a ring flange 6 with threaded boreholes for screwing in fastening screws 7 for the connection of the cylindrical generator casing 8, being clamped at both end faces over a plane area. The fastening screws 7 are distributed around the periphery at the inner side of the generator casing 8 and pass through the entire length of the casing.

At the left side of the generator casing 8, there is provided a casing cover 9, on which the stator 11 of the generator is fastened.

While there are eight fastening bolts 7 provided according to the present sample embodiment, distributed around the periphery, six stator bolts 17 are enough to fasten the stator, being screwed through boreholes in the stack of plates across spacer sleeves 20. Corresponding cutouts 38 in the stack of plates of the stator 11 accommodate the winding strands of the generator's rotary current winding 28.

The stator 11 is surrounded by the rotor 29, which is likewise constructed from a stack of plates, being clamped together by means of clamping bolts 30, which are screwed into corresponding threaded boreholes of the fan wheel 2 by a threaded end 31 at the motor side. Between fan wheel and the coordinated side of the rotor 29, supporting sleeves 32 are mounted, being fitted onto the clamping bolts 30. In this way, the rotor 29 is connected to the fan wheel 2 torsion-proof. At its inner circumference, it forms a narrow air gap 33, around 2 mm in width, relative to the stator 11. Furthermore, the rotor 29 has continuous pockets in the axial direction, running in approximately circular trend inside two segments, in which magnetic elements 35 are inserted on either side, namely, in the present example, as can be seen from FIG. 2, two rows per pole, each with ten magnetic elements 35 arranged alongside each other, being responsible for the magnetic excitation of the generator.

The view per FIG. 2 shows the rotor 29, which is fastened to the fan wheel 2 by four clamping bolts 30. At the inner circumference of the rotor 29 there are polygon-shaped cutouts, forming open pockets in which magnetic elements 35 are inserted in the two poles. In the region of the pockets, the inner contour line 36 of the rotor 29 together with the outer contour line 37 of the stator 11 bounds the narrow air gap 33. One notices not only the contour of the stack of plates forming the rotor 29, but also that of the stack of plates forming the stator, which have cutouts 38 to accommodate the winding wires.

As can be seen from FIG. 2, for the centering of the stator 11 in the rotor 29 there are centering grooves 39 cut out at the inner circumference of the rotor, having a cross-sectional profile in the shape of a partial circle. Opposite the centering grooves 39 of the rotor, centering grooves 41 are cut out in the outer circumference of the stator, being likewise formed with a cross-sectional profile in the shape of a partial circle (here, interrupted). The air gap is located between the centering grooves. A centering bolt 40 introduced into the centering grooves 39, 41 of the rotor and stator bridges the air gap 33.

For assembling of the electricity generating unit, the rotor 29 is first mounted on the fan wheel 2 of the drive motor. Next, two cylindrically shaped centering bolts are inserted into the centering grooves 39 of the rotor. Since the centering grooves of the rotor 29 are formed in the shape of a partial circle, they do not completely embrace the centering bolts in the radial direction, so that a portion of the centering bolts protrudes out from the centering grooves. The stator 11 is then introduced into the rotor along the portions of the centering bolts protruding from the centering grooves 39 of the rotor and entering into the centering grooves 41 of the stator and it is positioned with the same distance from the rotor about the outer circumference, i.e., centered inside the rotor 29. The inner circumferential surface of the rotor 29 and the outer circumferential surface of the stator 11 lie against the centering bolts 40. The stator 11 is then screwed together with the cover of the casing 9 in the centered position, and the cover of the casing 9 is fastened to the generator casing 8. Finally, the centering pins 40 are removed from the generator through holes 42 located in the cover of the casing 9.

The invention is not confined to the embodiment described and claimed. In particular, the relative position of rotor and stator can be symmetrically exchanged, i.e., the rotor can be formed as an internal rotor and the stator as an external stator.

1. Method for assembling of an electricity generating unit made from a generator and a reciprocating internal combustion engine as the drive, especially for the centering of an internal stator arranged inside an external rotor with an air gap, which method comprises the following steps:
mounting of the external rotor (29) onto the drive motor and connecting to its drive system;
inserting of at least two centering bolts (40) set off in the peripheral direction into centering grooves (39; 41) provided in the rotor/stator, for partially accommodating said centering bolts (40) which bridge the air gap (33), looking in the radial direction;
centering of the stator (11) in the rotor (29) by introducing the stator (11) inside the rotor (29) along the centering bolts (40);
fastening of the stator (11) to the generator casing (8) and fastening of the generator casing to a connection casing (5) of the drive motor;
removal of the centering bolts (40) from the air gap (33).

2. Method per claim 1, characterized in that the rotor is mounted on a fan wheel (2), which is fastened to a crankshaft (1) of the drive motor at its end face.

3. Method per claim 1, characterized in that the stator is fastened to a casing cover (9), which is to be fastened to the generator casing (8).

4. Method per claim 1, characterized in that the centering bolts (40) are removed from the generator through holes (42) arranged in the casing cover (9).

5. Method per claim 1, characterized in that the centering bolts (40) are turned for removal from the air gap (33).

6. Method per claim 5, characterized in that the centering bolts (40) are turned by holes (42) arranged in the casing cover.

7. Arrangement suitable for carrying out the method according to claim 1, with an electricity generating unit consisting of a generator and a reciprocating internal combustion engine as the drive, in particular, a synchronous generator and a Diesel motor, wherein the generator has an external rotor mounted on the drive motor and an internal stator fastened to the generator casing,
characterized in that the rotor (29) or stator (11) is provided with at least two axially extending centering grooves (39; 41), set off in the circumferential direction and open toward the air gap, on its circumferential surface bordering the air gap (33), in which a centering bolt (40) is partially accommodated, looking in the radial direction, and the other circumferential surface is centered on the centering bolt (40).

8. Arrangement per claim 7, characterized in that both circumferential surfaces are provided with centering grooves (39; 41), in which the centering bolts (40) are partially accommodated.

9. Arrangement per claim 7, characterized in that the rotor (29) is mounted on a fan wheel (2), fastened to a crankshaft (1) of the drive motor by its end face.

10. Arrangement per claim 7, characterized in that the rotor (29) is fashioned as a laminated iron plate stack, which carries the permanent magnets (35).

11. Arrangement per claim 7, characterized in that the stator (11) is fashioned as a laminated iron plate stack, which carries the armature winding.

12. Arrangement per claim 7, characterized in that the centering grooves (39; 41) have a cross-sectional profile in the shape of a partial circle.

13. Arrangement per claim 7, characterized in that the centering bolts (40) are cylindrically shaped.

14. Arrangement per claim 7, characterized in that the centering bolts (40) are present in the form of a cylinder cut along the cylinder's axis with a flat cross-sectional surface.

15. Arrangement per claim 7, characterized in that the casing cover (9) of the generator is provided with holes (42) for removal/turning of the centering bolts (40).
